(19) United States
(12) Patent Application Publication
(10) Pub. No.: US 2008/0207161 A1
(43) Pub. Date: Aug. 28, 2008

(54) METHOD AND APPARATUS TO FACILITATE HOTLINING IN A COMMUNICATION SYSTEM

(75) Inventors: Steven D. Upp, Bartlett, IL (US); Teodoro G. Alonso, Aurora, IL (US); Imran Raza, Lake Worth, FL (US)

Correspondence Address: MOTOROLA, INC., 1303 EAST ALGONQUIN ROAD, IL01/3RD, SCHAUMBURG, IL, 60196, US

(73) Assignee: MOTOROLA, INC., Schaumburg, IL (US)

(21) Appl. No.: 12/033,142

(22) Filed: Feb. 19, 2008

Related U.S. Application Data
(60) Provisional application No. 60/891,767, filed on Feb. 27, 2007.

(51) Int. Cl. H04M 11/04

(52) U.S. Cl. 455/404.1

(57) ABSTRACT

Various embodiments are described for facilitating hotlining in communication systems. A device (101) is informed by a device manager (131) that it is being hotlined and is provided certain hotlining state information. This information may enable devices with different types of user interfaces (browsers, automated clients, handsets, etc.) to trigger an appropriate application and begin communicating with an appropriate network location (in a secure and controlled fashion) to resolve the hotlining issue. The hotlining state information may also enable the device to access network services, while hotlined, such as emergency services. Assuming that a resolution to the hotlining is attained, the device may then be notified that hotlining has terminated. The device may then resume its access to regular network services, perhaps as gracefully as re-entering one or more data sessions interrupted by the hotlining.

### REFERENCE(S) TO RELATED APPLICATION(S)

The present application claims priority from a provisional application, Ser. No. 60/891,767, entitled “METHOD AND APPARATUS TO FACILITATE HOTLINING IN A COMMUNICATION SYSTEM,” filed Feb. 27, 2007, which is commonly owned and incorporated herein by reference in its entirety.

### FIELD OF THE INVENTION

The present invention relates generally to communication systems and, in particular, to facilitating hotlining in communication systems.

### BACKGROUND OF THE INVENTION

In general, hotlining is known in telecommunications as a process of (or the act of) diverting subscribers from services, destinations and/or their desired communication targets (e.g., from a desired callee or addressee) to a captive portal controlled by a network operator and/or service provider. Typically, a hotlined device is directed to (perhaps abruptly) a portal of some sort, and via which, the user's network access is limited to addressing the hotline-causing issue. For example, devices may be hotlined at initial activation, due to payment-related issues or due to security-related issues. Once the hotline-causing issue has been rectified, hotlining is released and the subscriber's access to network services is restored.

Today's newer communications systems, such as WiMAX (Worldwide Interoperability for Microwave Access) systems, are being designed to provide access to a variety of newer device types. Examples include: laptops with browsers, cellular form factor handsets, non-user-interface (non-UI) devices (such as Voice over Internet Protocol (VoIP) Multimedia Terminal Adapter devices), etc.

One problem for today's newer communications systems is how to provide a common framework for the online activation and maintenance of such a variety of devices independent of their individual access technologies and capabilities. Hence, it would be desirable to have a method and apparatus for facilitating hotlining that was both more flexible and more robust than is presently available and thereby able to effectively accommodate a greater variety of access devices.

### BRIEF DESCRIPTION OF THE DRAWINGS

FIG. 1 is a block diagram depiction of a wireless communication system in accordance with multiple embodiments of the present invention.

FIG. 2 is a signaling flow diagram that depicts hotlining at the time of device activation, in accordance with multiple embodiments of the present invention.

FIG. 3 is a signaling flow diagram that depicts an example of mid-session hotlining, in accordance with multiple embodiments of the present invention.

FIG. 4 is a block diagram depicting a representation of an example SyncML information tree that may be provided to a hotlined remote unit, in accordance with multiple embodiments of the present invention.

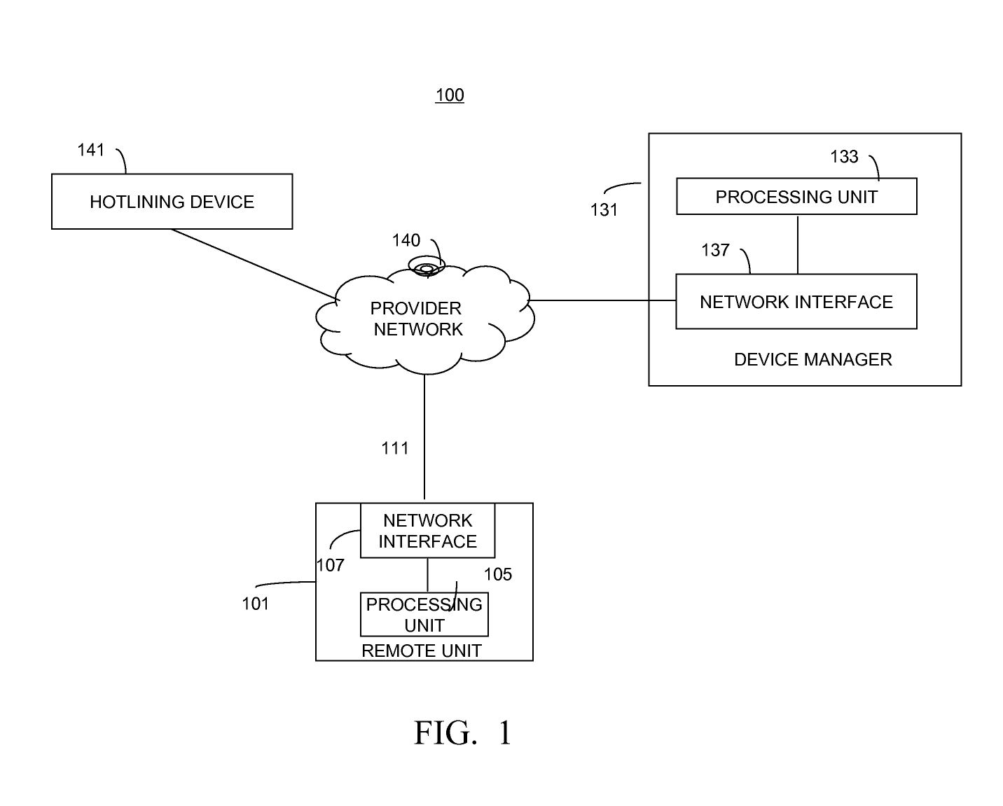

Specific embodiments of the present invention are disclosed below with reference to FIGS. 1-4. Both the description and the illustrations have been drafted with the intent to enhance understanding. For example, the dimensions of some of the figure elements may be exaggerated relative to other elements, and well-known elements that are beneficial or even necessary to a commercially successful implementation may not be depicted so that a less obstructed and a more clear presentation of embodiments may be achieved. In addition, although the signaling flow diagrams above are described and shown with reference to specific signaling exchanged in a specific order, some of the signaling may be omitted or some of the signaling may be combined, sub-divided, or reordered without departing from the scope of the claims. Thus, unless specifically indicated, the order and grouping of the signaling depicted is not a limitation of other embodiments that may lie within the scope of the claims.

Simplicity and clarity in both illustration and description are sought to effectively enable a person of skill in the art to make, use, and best practice the present invention in view of what is already known in the art. One of skill in the art will appreciate that various modifications and changes may be made to the specific embodiments described below without departing from the spirit and scope of the present invention. Thus, the specification and drawings are to be regarded as illustrative and exemplary rather than restrictive or all-encompassing, and all such modifications to the specific embodiments described below are intended to be included within the scope of the present invention.

### DETAILED DESCRIPTION OF EMBODIMENTS

Various embodiments are described for facilitating hotlining in communication systems. A device is informed by a device manager that it is being hotlined and is provided certain hotlining state information. This information may enable devices with different types of user interfaces (browsers, automated clients, handsets, etc.) to trigger an appropriate application and begin communicating with an appropriate network location (in a secure and controlled fashion) to resolve the hotlining issue. The hotlining state information may also enable the device to access network services, while hotlined, such as emergency services. Assuming that a resolution to the hotlining is attained, the device may then be notified that hotlining has terminated. The device may then resume its access to regular network services, perhaps as gracefully as re-entering one or more data sessions interrupted by the hotlining.

The disclosed embodiments can be more fully understood with reference to FIGS. 1-4. FIG. 1 is a block diagram depiction of a wireless communication system 100 in accordance with multiple embodiments of the present invention. At present, standards bodies such as OMA (Open Mobile Alliance), 3GPP (3rd Generation Partnership Project), 3GPP2 (3rd Generation Partnership Project 2), IEEE (Institute of Electrical and Electronics Engineers) 802, and WiMAX Forum are developing standards specifications for wireless telecommunications systems. (These groups may be contacted via http://www.openmobilealliance.com, http://www.3gpp.org/, http://www.3gpp2.com/, http://www.ieee802.org/, and http://www.wimaxforum.org/ respectively.) Communication system 100 represents a system having an architecture in accordance with one or more of the WiMAX Forum and/or IEEE 802 technologies, suitably modified to implement the present invention. Alternative embodiments of the present invention may be implemented in communication systems that employ other or additional technologies such as, but not limited to, those described in the OMA, 3GPP, and/or 3GPP2 specifications.

Communication system 100 is depicted in a very generalized manner. In particular, device manager (DM) 131, hotlining device 141 and remote unit 101 are shown communicating via a provider network 140. Remote unit 101 is depicted as communicating with provider network 140 via interface 111. Depending on the embodiment, interface 111 may represent either a wired interface of some sort or a wireless interface, such as an IEEE 802.16-based wireless interface. Those skilled in the art will recognize that FIG. 1 does not depict all of the physical fixed network components that may be necessary for system 100 to operate but only those system components and logical entities particularly relevant to the description of embodiments herein. For example, provider network 140, in some embodiments, may include one or more access points (APs) to support wireless interfaces, such as that depicted with remote unit 101.

FIG. 1 depicts remote unit 101 and DM 131 as respectively comprising processing units 105 and 133 and network interfaces 107 and 137. Of course, in embodiments in which remote unit 101 is a wireless device, network interface 107 comprises a transceiver. In general, components such as processing units, transceivers and network interfaces are well-known. For example, processing units are known to comprise basic components such as, but neither limited to nor necessarily requiring, microprocessors, microcontrollers, memory devices, application-specific integrated circuits (ASICs), and/or logic circuitry. Such components are typically adapted to implement algorithms and/or protocols that have been expressed using high-level design languages or descriptions, expressed using computer instructions, expressed using signaling flow diagrams, and/or expressed using logic flow diagrams.

Thus, given a high-level description, an algorithm, a logic flow, a messaging/signaling flow, and/or a protocol specification, those skilled in the art are aware of the many design and development techniques available to implement a processing unit that performs the given logic. Therefore, remote unit 101 and DM 131 represent known devices that have been adapted, in accordance with the description herein, to implement multiple embodiments of the present invention. Furthermore, those skilled in the art will recognize that aspects of the present invention may be implemented in and across various physical components and none are necessarily limited to single platform implementations. For example, processing unit 133 and network interface 137 may be implemented in or across one or more network components, such as one or more server devices in a device management subsystem. Similarly, processing unit 105 and network interface 107 may be implemented in or across one or more components, such as one or more processors/memory devices associated with one or more computers (whether handheld, laptop or desktop) and their associated peripheral devices.

In some embodiments, as noted above, remote unit 101 may represent a wireless device. Wireless devices, subscriber stations (SSs) or user equipment (UEs), may be thought of as mobile stations (MSs); however, wireless devices are not necessarily mobile nor able to move. In addition, wireless device platforms are known to refer to a wide variety of consumer electronic platforms such as, but not limited to, mobile stations (MSs), access terminals (ATs), terminal equipment, mobile devices, gaming devices, personal computers, and personal digital assistants (PDAs). In general, a wireless device comprises a processing unit and a network interface that includes a transceiver. Depending on the embodiment, a wireless device may additionally comprise a keypad (not shown), a speaker (not shown), a microphone (not shown), and a display (not shown). Processing units, transceivers, keypads, speakers, microphones, and displays as used in wireless device are all well-known in the art. Thus, given a high-level description, an algorithm, a logic flow, a messaging/signaling flow, and/or a protocol specification, those skilled in the art are aware of the many design and development techniques available to implement a processing unit that performs the given logic. Therefore, remote unit 101 may represent a known wireless device that has been adapted, in accordance with the description herein, to implement multiple embodiments of the present invention.

Operation of embodiments in accordance with the present invention occurs substantially as follows, first with reference to FIG. 1. In many embodiments of the present invention, remote unit 101 and DM 131 communicate to establish a secure relationship when remote unit 101 is first activated by the network. This communication may be part of the bootstrap signaling that occurs between remote unit 101 and DM 131. For example, DM processing unit 133 may send via network interface 137 bootstrap information that is encrypted with a certificate of DM 131. Such bootstrap information facilitates the binding of remote unit 101 to DM 131, thereby establishing DM 131 as a trusted DM for remote unit 101.

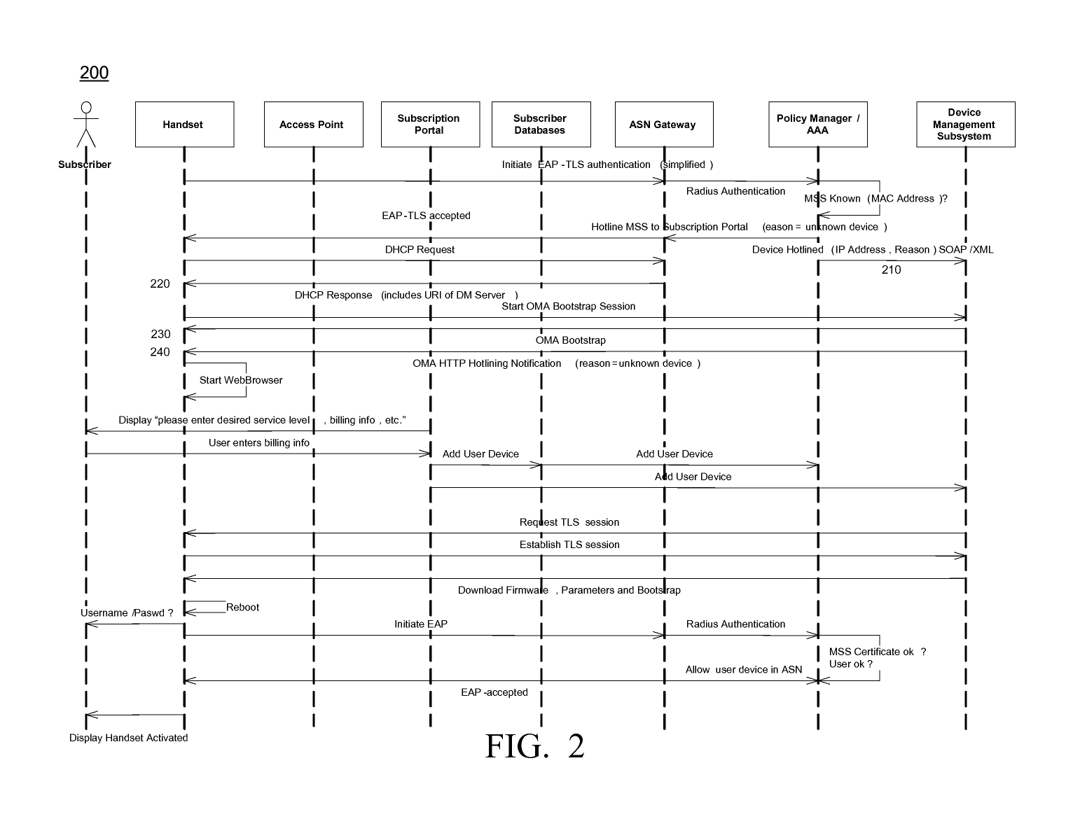

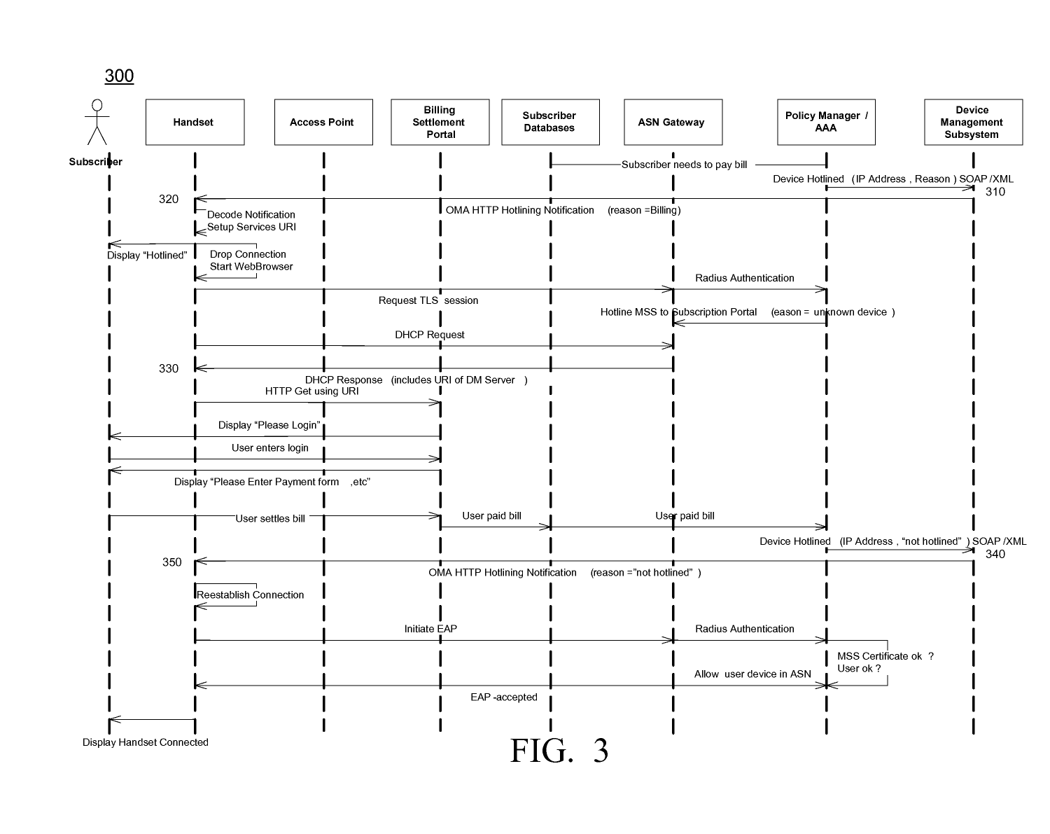

To provide some specific, detailed examples, FIGS. 2-4 will be referenced in the description that follows. FIGS. 2 and 3 depict signaling flow diagrams (200 and 300) in accordance with multiple embodiments of the present invention. More particularly, however, they are directed toward systems having architectures/performing signaling similar to those being developed by the WiMAX Forum and/or the IEEE 802 organizations. Both FIGS. 2 and 3 depict specific signaling examples taken from very specific hotlining signaling flow embodiments. FIG. 2 depicts hotlining at the time of device activation, while FIG. 3 depicts an example of mid-session hotlining.

For example, signaling 230 is an example of bootstrap signaling that the remote unit uses to bind itself to the DM. In diagrams 200 and 300, the handset corresponds to remote unit 101, the device management subsytem corresponds to DM 131 and the policy manager/AAA corresponds to hotlining device 141. The access point, subscription portal, subscriber databases and access service network (ASN) gateway can be thought of as representing device either within or interfacing with provider network 140.

Hotlining device 141 determines or is made aware of an event or condition in which some hotlining issue is present. Examples of hotlining issues include the remote unit has not been activated yet, a bill for services has not been timely paid, a pre-paid account has been depleted, a security issue involving the remote unit has been detected. DM 131 receives from hotlining device 141 an indication that remote unit 101 is being hotlined. In diagram 200, signaling 210 is an example of such an indication being sent at the time of activation, while signaling 310 in diagram 300 is an example of such an indication being sent after activation due to a bill-payment issue. In both examples, signaling 210 and 310 utilize SOAP/XML (simple object access protocol/extensible markup language) and provide a reason for the hotlining. Depending on the embodiment, however, something other than SOAP/XML may be used, of course, XML being merely one example.

In response to the indication that remote unit 101 is being hotlined, DM 131 sends a notification of such to remote unit 101 and includes associated hotlining state information to facilitate a hotlining resolution. Signaling 240 is an example of such a notification being sent at the time of activation, while signaling 320 is an example of such a notification being sent after activation. In both examples, signaling 240 and 320 provide a reason for the hotlining. Depending on the embodiment, the notification that is sent may take various forms. Examples include an Open Mobile Alliance (OMA) server alerted notification (SAN) packet, a SyncML information tree, a HyperText Transfer Protocol (HTTP) packet, a user datagram protocol (UDP) packet, short message service (SMS) packet, a SOAP/XML (simple object access protocol/extensible markup language) packet, and an XML packet.

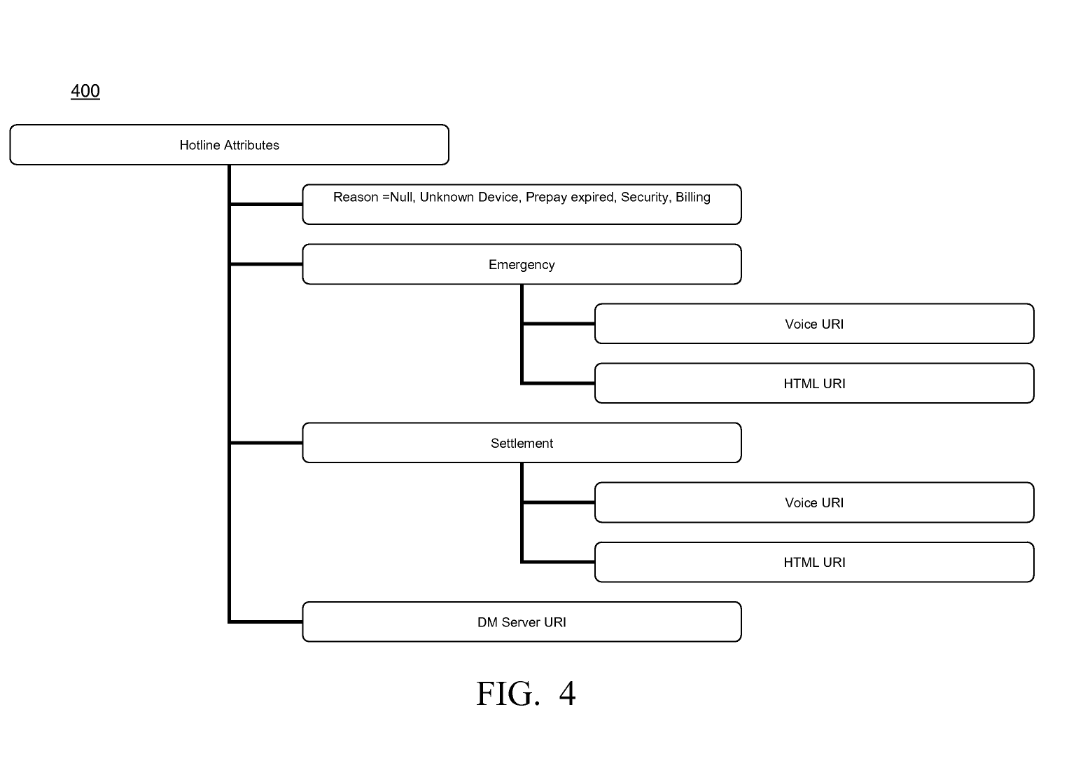

In many embodiments, the associated hotlining state information that is sent to remote unit 101 includes one or more uniform resource identifiers (URIs) to facilitate a hotlining resolution. One way that this may be done is by sending the URIs in the form of a SyncML information tree. FIG. 4 is a block diagram depicting a representation of an example SyncML information tree 400.

The remote unit 101 receives the notification that it is being hotlined and the associated hotlining state information from DM 131 and uses the information to interface a user to the appropriate network device to resolve the outstanding hotlining issue. Depending on the embodiment, and any of the remote unit 101's capabilities, the user interface it provides, the applicable user preferences, and the indicated reason for hotlining, remote unit 101 may interface its user in many different ways. For example, processing unit 105 selects one of the URIs indicated in the hotlining state information and a user interface to provide based on one or more of these factors. Thus, as examples, processing unit 105 via network interface 107 may provide a web browser interface to the selected URI, may provide a setup wizard to establish a connection to the selected URI, or may initiate a call to the selected URI. For example, remote unit 101 could initiate a call (a SIP call, e.g.) to a customer service representative.

In addition to interfacing the user to a selected URI to facilitate a hotlining resolution, remote unit 101 may also detect that an emergency condition exists while it is hotlined. For example, the user may press an emergency button or dial a number such as “911” that is recognized for emergency purposes. Similar to the manner in which processing unit 105 selects one of the URIs and a user interface to facilitate a hotline resolution, processing unit 105 selects one of the URIs and a user interface to facilitate emergency assistance while remote unit 101 is still hotlined. For example, as depicted in information tree 400, remote unit 101 would select either the voice URI or the HTML URI under emergency when interfacing the user. Assuming that remote unit 101 supports voice calls, the voice URI would likely be the preferred choice. Remote unit 101 would then initiate a call (a SIP call, e.g.) to an emergency dispatcher. However, if remote unit 101 does not support voice calls, an HTML interface to the provided URI could be provided instead.

As described above, the hotlining notification is received by remote unit 101 without being first requested. However, in certain situations in some embodiments, remote unit 101 may request the notification and/or the associated hotlining state information. For example, remote unit 101 may be aware that it has been hotlined by the network, but it did not yet receive the associated hotlining state information. Having received a URI of DM 131, remote unit 101 may simply request hotlining-related information from DM 131 using the DM URI. Signaling 220 and 330 (both dynamic host configuration protocol (DHCP) response messages) are examples of signaling that may include the DM URI. (In some embodiments, a DHCP server populates Vendor Specific Information with the DM URI, since the DHCP protocol allows vendor specific information to be conveyed to IP hosts via Vendor Specific Information (option 43).) In some embodiments, a secure session (such as a secure SyncML session or a secure XML session) is established between remote unit 101 and DM 131 for sending the hotline notification and the associated hotlining state information. The use of a secure session and the binding of remote unit 101 to DM 131, as described previously, serve to prevent remote unit 101 from re-registering with another AP (perhaps owed by identity thieves), being hotlined, and then being queried for billing/payment information. Remote unit 101 may not interface its user to another network's hotline portal without first requesting a hotline notification from DM 131. If it is unable to get a hotline notification from its trusted DM, DM 131, remote unit 101 could instead notify its user of the insecure network. However, some embodiments may not utilize DM binding or secure sessions.

If the hotlining issue can be resolved, DM 131 may receive an indication from hotlining device 141 that remote unit 101 is no longer hotlined. In response, DM 131 may send a notification to remote unit 101 that it is no longer hotlined. Signaling 340 and 350 are examples of such signaling. Upon receiving such a notification, remote unit 101 may do one or more of the following (perhaps as indicated by the notification itself): reboot, restart client mobile internet protocol (MIP) operation, send a registration request, and/or send a dynamic host configuration protocol (DHCP) request. If remote unit 101 was able to save the session state of any pending sessions at the time of receiving the hotline notification, then remote unit 101 may attempt to resume or re-enter these interrupted sessions after getting the notice that it is no longer hotlined.

For embodiments that utilize Mobile IPv4 (see RFC 3220), the hotlining notifications may be implemented using an extension to Mobile IPv4. So as to not violate Mobile IPv4 parsing, such an extension would need to occur after the authentication extensions, which include the Mobile-Home Authentication Extension, the Mobile-Foreign Authentication Extension, and the Foreign-Home Authentication Extension.

To provide some further context for embodiments of the present invention and to supplement the signaling depictions of FIG. 2, some additional description is provided below. The description is in the form of a list of steps that a system may take (although not necessarily in the strict order of the following listing) when activating a device:
Hotlining Device (such as ASN Gateway) receives a Radius authorization with a request to hotline a Device attempting to establish a new session due to one of predefined policies stored in the AAA (Unknown device, Billing, etc.)
Hotlining Device notifies the Device Manager using SOAP/XML to create the appropriate OMA Server Alerted Notification to indicate the Hotlined Status of the Device.
   Permits DM Server to pre-fetch the Subscriber Information if you are adding a device to an existing account.
   Also it allows the creation of different URI sets based on the user.
If Device is using Client Mobile IP it receives a registration response that includes the URI of the DM Server. Device turns-off Client MIP.
Device is hotlined to VLAN or by use of IP filters.
Device is sent authorization response.
Device issues DHCP request.
Device receives DHCP Response that contains URI of DM Server.
Device Establishes Secure SyncML Session with DM Server.
If the device is not known to the DM Server, for example, during initial activation, an OMA DM Bootstrap is required to install OMA Server Id and nonce.
Server Alerted Notification packet is sent with standard SyncML Tree that contains Hotlining State Information.
User interacts with the Issue Resolution Server (Captive Portal) via the supported methods defined in the OMA SAN Packet to resolve the issue causing the hotlined state.
Issue Resolution Server reports to the Subscriber Management DB that the issue has been resolved or that the Device needs to be added to a Subscriber Account.
The Subscriber Management DB notifies the Policy Manager that the Device should be admitted in the Network.
Policy Managers updates the AAA.
AAA that issued the original hotlining request now issues a Radius Change of Authorization to the Hotlining Device.
Hotlining Device ends Device Hotlining.
Hotlining Device Notifies the Device Manager to send a OMA SAN Packet to the Device indicating that it is no longer hotlined.
If this is a new device activation the DM Server requests a reboot of the device (in the case of a PCMCIA card this will reboot the laptop).
If Client MIP Device then Device turns Client MIP on and issues a new Registration Request.
Otherwise Device issues a DHCP request.
Device receives DHCP Response or Registration Response.

To provide some further context for embodiments of the present invention and to supplement the signaling depictions of FIG. 3, some additional description is provided below. The description is in the form of a list of steps that a system may take (although not necessarily in the strict order of the following listing) when hotlining a device mid-session:
Hotlining Device (such as ASN Gateway) receives a Radius COA with a request to hotline a Device in Mid-session due to one of predefined policies stored in the AAA (Unknown device, Billing, etc.).
Hotlining Device notifies the Device Manager using SOAP/XML to deliver the appropriate OMA Server Alerted Notification to indicate the Hotlined Status of the Device.
Device receives the Hotline notification. Device serializes current session state.
If Device is using Client Mobile IP it turns-off Client MIP.
Device drops connection
Same steps as in Hotlining at activation are performed. (See list above.)
Device restores serialized session.

One of skill in the art will appreciate that various modifications and changes may be made to the specific embodiments described above without departing from the spirit and scope of the present invention. Thus, the discussion of certain embodiments in greater detail above is to be regarded as illustrative and exemplary rather than restrictive or all-encompassing, and all such modifications to the specific embodiments described above are intended to be included within the scope of the present invention.

Benefits, other advantages, and solutions to problems have been described above with regard to specific embodiments of the present invention. However, the benefits, advantages, solutions to problems, and any element(s) that may cause or result in such benefits, advantages, or solutions, or cause such benefits, advantages, or solutions to become more pronounced are not to be construed as a critical, required, or essential feature or element of any or all the claims.

As used herein and in the appended claims, the term “comprises,” “comprising,” or any other variation thereof is intended to refer to a non-exclusive inclusion, such that a process, method, article of manufacture, or apparatus that comprises a list of elements does not include only those elements in the list, but may include other elements not expressly listed or inherent to such process, method, article of manufacture, or apparatus. The terms a or an, as used herein, are defined as one or more than one. The term plurality, as used herein, is defined as two or more than two. The term another, as used herein, is defined as at least a second or more. Unless otherwise indicated herein, the use of relational terms, if any, such as first and second, and the like, are used solely to distinguish one entity or action from another entity or action without necessarily requiring or implying any actual such relationship or order between such entities or actions.

The terms including and/or having, as used herein, are defined as comprising (i.e., open language). The term coupled, as used herein, is defined as connected, although not necessarily directly, and not necessarily mechanically. Terminology derived from the word “indicating” (e.g., “indicates” and “indication”) are intended to encompass all the various techniques available for communicating or referencing the object being indicated. Some, but not all examples of techniques available for communicating or referencing the object being indicated include the conveyance of the object being indicated, the conveyance of an identifier of the object being indicated, the conveyance of information used to generate the object being indicated, the conveyance of some part or portion of the object being indicated, the conveyance of some derivation of the object being indicated, and the conveyance of some symbol representing the object being indicated. The terms program, computer program, and computer instructions, as used herein, are defined as a sequence of instructions designed for execution on a computer system. This sequence of instructions may include, but is not limited to, a subroutine, a function, a procedure, an object method, an object implementation, an executable application, an applet, a servlet, a shared library/dynamic load library, a source code, an object code and/or an assembly code.

What is claimed is:

1. A method for facilitating hotlining in a communication system comprising:
communicating by a device manager (DM) with a remote unit to establish a secure relationship with the remote unit;
receiving by a device manager (DM) an indication that the remote unit is being hotlined;
sending, by the DM to the remote unit in response to the indication that the remote unit is being hotlined, a notification that the remote unit is being hotlined and associated hotlining state information to facilitate a hotlining resolution.

2. The method of claim 1, wherein communicating by the DM with the remote unit to establish the secure relationship comprises
sending bootstrap information to the remote unit to facilitate binding of the remote unit to the DM.

3. The method of claim 1, further comprising
receiving by the DM an indication that the remote unit is no longer hotlined;
sending, by the DM to the remote unit in response to the indication that the remote unit is no longer hotlined, a notification that the remote unit is no longer hotlined.

4. The method of claim 3, wherein the notification that the remote unit is no longer hotlined indicates that the remote unit should reboot.

5. The method of claim 1, wherein receiving by the device manager the indication that the remote unit is being hotlined comprises
receiving the indication via SOAP/XML (simple object access protocol/extensible markup language).

6. The method of claim 1, wherein sending the notification that the remote unit is being hotlined and the associated hotlining state information comprises
indicating at least one URI to facilitate a hotlining resolution.

7. The method of claim 1, wherein sending the notification that the remote unit is being hotlined and the associated hotlining state information comprises
sending at least one of
an Open Mobile Alliance (OMA) server alerted notification (SAN) packet,
a SyncML information tree,
a HyperText Transfer Protocol (HTTP) packet,
a user datagram protocol (UDP) packet,
short message service (SMS) packet,
a SOAP/XML (simple object access protocol/extensible markup language) packet, and
an XML packet.

8. A method for facilitating hotlining in a communication system comprising:
receiving by a remote unit a uniform resource identifier (URI) of a device manager (DM);
communicating by the remote unit with the DM to establish a secure relationship with the DM;
receiving, by the remote unit from the DM, a notification that the remote unit is being hotlined and associated hotlining state information;
interfacing a user of the remote unit with a network device, as indicated by the hotlining state information, to facilitate a hotlining resolution.

9. The method of claim 8, wherein communicating by the remote unit with the DM to establish the secure relationship comprises
receiving bootstrap information by the remote unit from the DM;
binding by the remote unit to the DM.

10. The method of claim 8, further comprising requesting by the remote unit hotlining-related information from the DM using the URI of the DM.

11. The method of claim 8, wherein interfacing the user of the remote unit with the network device comprises
selecting a URI indicated in the hotlining state information.

12. The method of claim 11, wherein interfacing the user of the remote unit with the network device comprises performing at least one of
providing web browser interface to the selected URI,
providing a setup wizard to establish a connection to the selected URI, and
initiating a SIP call to the selected URI.

13. The method of claim 12, wherein initiating the SIP call to the selected URI comprises
initiating a SIP call to one of an emergency dispatcher and a customer service representative.

14. The method of claim 8, further comprising communicating by the remote unit with the DM to establish a secure session with the DM,
wherein the notification that the remote unit is being hotlined and the associated hotlining state information are received via the secure session and
wherein the secure session comprises at least one of
a secure SyncML session and
a secure extensible markup language (XML) session.

15. The method of claim 8, wherein receiving the notification that the remote unit is being hotlined and the associated hotlining state information comprises
receiving at least one of
an Open Mobile Alliance (OMA) server alerted notification (SAN) packet,
a SyncML information tree,
a HyperText Transfer Protocol (HTTP) packet,
a user datagram protocol (UDP) packet,
short message service (SMS) packet,
a SOAP/XML (simple object access protocol/extensible markup language) packet, and
an XML packet.

16. The method of claim 8, further comprising
receiving, by the remote unit from the DM, a notification that the remote unit is no longer hotlined.

17. The method of claim 16, further comprising
performing, by the remote unit in response to the notification that the remote unit is no longer hotlined, at least one of
rebooting,
restarting client mobile internet protocol (MIP) operation,
sending a registration request, and
sending a dynamic host configuration protocol (DHCP) request.

18. A method for facilitating hotlining in a communication system comprising:
receiving, by a remote unit from a device manager (DM), a notification that the remote unit is being hotlined and associated hotlining state information, wherein the associated hotlining state information comprises a first uniform resource identifier (URI) and a second URI;
interfacing, by the remote unit while hotlined, a user of the remote unit with a network device using the first URI, to facilitate a hotlining resolution;
detecting, by the remote unit while hotlined, that an emergency condition exists;
interfacing, by the remote unit while hotlined, the user of the remote unit with a network device using the second URI, to facilitate emergency assistance.

19. A remote unit comprising:
a network interface;
a processing unit, communicatively coupled to the network interface,
adapted to receive via the network interface a uniform resource identifier (URI) of a device manager (DM),
adapted to communicate via the network interface with the DM to establish a secure relationship with the DM,
adapted to receive, from the DM via the network interface, a notification that the remote unit is being hotlined and associated hotlining state information, and
adapted to interface via the network interface a user of the remote unit with a network device, as indicated by the hotlining state information, to facilitate a hotlining resolution.
